(19) United States
(12) Patent Application Publication
(10) Pub. No.: US 2007/0258741 A1
(43) Pub. Date: Nov. 8, 2007

(54) Fusing unit for an image forming apparatus and an image forming apparatus having the same

(75) Inventors: Jeong-wha Kim, Suwon-si (KR); Seung-jun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/650,970

(22) Filed: Jan. 9, 2007

(30) Foreign Application Priority Data
May 3, 2006 (KR) 2006-40050

(51) Int. Cl. G03G 15/20

(52) U.S. Cl. 399/329

(57) ABSTRACT

A fusing unit for an image forming apparatus has a heating roller, and a fusing belt assembly that rotates in contact with the heating roller. The fusing belt assembly comprises a pressure roller, a separating roller and a fusing belt rotatably supported by the pressure roller and the separating roller. A slip prevention element prevents slippage of the fusing belt. Because the slip prevention element is disposed at both ends of the separating roller so that it does not interfere with the paper sheet being fused, the quality of printing can be improved without shortening the life of the fusing belt.

### CROSS-REFERENCE TO RELATED APPLICATIONS

This application claims the benefit under 35 U.S.C. §119(a) of Korean Patent Application No. 2006-40050, filed on May 3, 2006, in the Korean Intellectual Property Office, the entire disclosure of which is hereby incorporated by reference.

### BACKGROUND OF THE INVENTION

1. Field of the Invention

The present invention relates to a fusing unit for an image forming apparatus. More particularly, the present invention relates to a belt-type fusing unit for an image forming apparatus and an image forming apparatus having the same.

2. Description of the Related Art

A fusing unit for an image forming apparatus fuses a toner image onto a sheet of paper by applying heat and pressure to a sheet of paper carrying a toner image.

FIG.1 illustrates a conventional fusing unit 1 for an image forming apparatus. As shown in FIG. 1, the fusing unit 1 includes a heating roller 10, and a pressure roller 20.

The heating roller 10 is formed by a metal core pipe 11 with a heat source 12 disposed inside the pipe 11. The heating roller 10 receives rotational force from a power transmission unit. An elastic rubber surface layer 13 is formed on the surface of the heating roller 10.

The pressure roller 20 includes a metal core pipe 21 and a rubber layer 22 formed on the surface of the metal core pipe 21. The pressure roller 20 faces the heating roller 10 to form a nip between the rollers, and is passively driven by the heating roller 10. Passively driven means that the heating roller is driven by power transmitted through contact with the heating roller, and not through a separate power source.

The heat source 12 raises the surface temperature of the heating roller 10 when paper bearing an un-fused toner image enters the nip between the heating roller 10 and the pressure roller 20. As the pressure roller 20 is pressed against the heating roller 10, the heating roller 10 and the pressure roller 20 apply heat and pressure to the paper in the nip.

Throughout the description and claims, the term ‘nip’ refers to the contact area formed between the heating roller 10 and the pressure roller 20 when the surface of the heating roller 10 is squeezed by the relatively flexible surface of the pressure roller 20.

Recently, demand for high-speed color image forming apparatuses has been increasing. One result of the increase in speed of the image forming apparatuses is that the paper is located in the fuser nip for less time. This may degrade image fusing quality. To prevent this, it has been suggested that the size of the rollers or the thickness of the rubber layer may be increased to prevent deterioration of the fusing quality.

There are, however, limits to the size of an image forming apparatus. Thus, the size of each roller can only be marginally increased. Furthermore, any increase in roller size increases warm-up time and increases the cost of production. Another possible method of addressing image degradation is to increase the temperature of the fusing unit. Too high a temperature, however, can cause image deterioration and can damage other components.

Furthermore, as shown in the graphical representation of FIG. 2, the pressure between the heating roller 10 and the pressure roller 20 forms a parabolic curve with the peak pressure in the middle. This type of curve may cause a wrap jam, which is a paper jam where the paper fused with the toner image rolls around the surface of the heating roller 10 at the end of the nip.

Accordingly, there is a need for an improved fusing unit for a high speed image forming apparatus, and an image forming apparatus having the same.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a fusing unit for an image forming apparatus, which has an extended nip to increase the time that a paper bearing a toner image is fused, and thus provide good image fixation at a lower fusing temperature.

Another object of the present invention is to provide a fusing unit having an improved structure that provides stable rotation with a fusing belt, and prevents slippage of the fusing belt.

Still another object of the present invention is to provide an image forming apparatus having the above-mentioned fusing unit to generate good quality images without compromising the lifespan of the fusing belt.

In accordance with an aspect of exemplary embodiments of the present invention, a fusing unit for an image forming apparatus comprises a heating roller and a fusing belt assembly rotating in contact with the heating roller. The fusing belt assembly comprises a pressure roller, a separating roller and a fusing belt rotatably supported by the pressure roller and the separating roller. A slip prevention element prevents slippage of the fusing belt.

The fusing belt assembly may be passively driven by the rotation of the heating roller. The slip prevention element may be formed at both sides of at least one of the separating roller, the pressure roller and an inner surface of the fusing belt.

According to a first exemplary embodiment of the present invention, the slip prevention element may comprise recesses formed on both sides of the separating roller, and a friction material in the recesses. The slip prevention element may be arranged to contact the fusing unit outside of the paper transferring path. The slip prevention element may extend inward approximately 1 or 2 centimeters from both ends of the separating roller.

According to a second exemplary embodiment of the present invention, the slip prevention element may comprise slits formed at intervals on both ends of the separating roller, and a friction material in the slits.

According to a third exemplary embodiment of the present invention, the slip prevention element may comprise recesses laterally extending inwards from both ends of the pressure roller by approximately 1 or 2 centimeters, and a friction material in the recesses. The slip prevention element may be aligned with the surface of the pressure roller, and/or the pressure roller, and/or the fusing belt having the slip prevention element.

The slip prevention element may contact the fusing belt in an area outside of a paper transferring path.

According to a fourth exemplary embodiment of the present invention, the slip prevention element may comprise slits formed at intervals on both ends of the pressure roller, and friction material in the slits.

According to a fifth exemplary embodiment of the present invention, the slip prevention element may comprise recesses formed on the edges of the inner surface of the fusing belt, and a friction material in the recesses.

According to a sixth exemplary embodiment of the present invention, the slip prevention element may comprise recesses formed at intervals on the edges of the inner surface of the fusing belt, and a friction material in the recesses.

In the first to sixth exemplary embodiments, the friction material may comprise any one of a silicon rubber, a urethane and an Expandable Polystyrene (EPS).

The fusing belt assembly may be pressed against the heating roller to form a nip therebetween.

The separating roller and the fusing belt may be wider than the width of a paper transferring path so that the slip prevention element does not interfere with the paper transferring path. Alternatively, the pressure roller, the separating roller and the fusing belt may be wider than the paper transferring path.

In accordance with another aspect of the present invention, an image forming apparatus may be provided. The image forming apparatus comprises a feeding unit holding a stack of paper, a conveyer that conveys a sheet of paper from the stack of paper, a developing unit and a image transfer unit for developing and transferring a toner image onto the conveyed sheet of paper, a fusing unit for fusing the toner image onto the sheet of paper by applying heat and pressure to the sheet of paper bearing the toner image, and a discharging unit for discharging the paper sheet with the fused image. The fusing unit includes a heating roller and a fusing belt assembly rotating in contact with the heating roller. The fusing belt assembly comprises a pressure roller, separating roller and a fusing belt rotatably supported by the pressure roller and the separating roller. A slip prevention element prevents slippage of the fusing belt.

In accordance with another aspect of the present invention, a fusing belt for a fusing unit for an image forming apparatus comprises an endless belt having an inner surface and a slip prevention element disposed on an inner surface of the fusing belt.

In accordance with another aspect of the present invention, a fusing unit for an image forming apparatus comprises a heating roller, a pressure roller opposed to the heating roller, a separating roller opposed to the heating roller, a fusing belt passing between the pressure roller and the heating roller and between the separating roller and the heating roller, and means for preventing slippage of the fusing belt.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic illustration of a conventional fusing unit;

FIG. 2 is a graphical representation of pressure distribution in a fusing unit of a conventional image forming apparatus;

FIG. 3 is a schematic illustration of a fusing unit according to a first exemplary embodiment of the present invention;

FIG. 4 is a perspective view of a separating roller that supports the fusing belt of FIG. 3;

FIG. 5 is a schematic illustration of a fusing unit according to a second exemplary embodiment of the present invention;

FIG. 6 is a perspective view of a separating roller that supports the fusing belt of FIG. 5;

FIG. 7 is a sectional view of the contact area between the fusing belt and the separating roller;

FIG. 8 is a schematic view of a fusing unit according to a third exemplary embodiment of the present invention;

FIG. 9 is a perspective view of a pressure roller that supports the fusing belt of FIG. 9;

FIG. 10 is a schematic view of a fusing unit according to a fourth exemplary embodiment of the present invention;

FIG. 11 is a perspective view of a pressure roller that supports the fusing belt of FIG. 10;

FIG. 12 is a perspective view of a fusing belt according to a fifth exemplary embodiment of the present invention;

FIG. 13 is a perspective view of a fusing belt according to a sixth exemplary embodiment of the present invention; and

FIG. 14 is a schematic view of an exemplary embodiment of an image forming apparatus having a fusing unit according to an exemplary embodiment of the present invention.

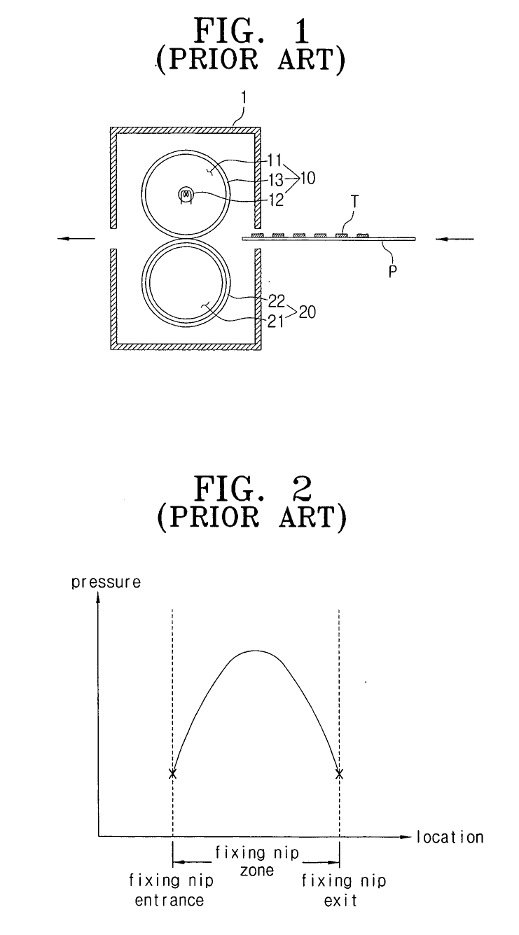

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness

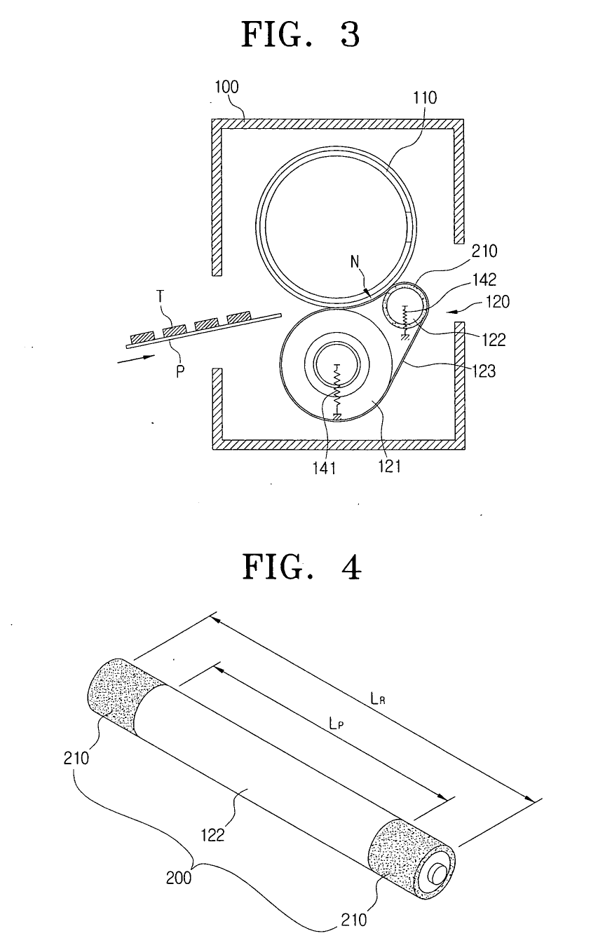

Referring initially to FIGS. 3, 5, 8, 10, in exemplary embodiments of the present invention, the fusing unit 100 includes a heating roller 110 and a fusing belt assembly 120.

The heating roller 110 is a rigid pipe, such as an aluminum or steel pipe, with a heat source inside, and layers applied on the core pipe such as a rubber layer, or a paper release layer. The heating roller 110 is controlled to maintain the temperature around 180° C., and rotated by power received from a driving source.

The fusing belt assembly 120 includes a pressure roller 121, a separating roller 122 and a fusing belt 123, which are passively driven by the rotation of the heating roller 110. Although not illustrated, the fusing belt assembly 120 may be constructed so that one or both of the pressure roller 121 and/or the separating roller 122 are actively driven.

The pressure roller 121 includes a rigid pipe, which is made of a metal such as steel or the like, and an elastic rubber coating around the rigid pipe. A pressure roller supporting elastic element 141 is disposed at the axis of rotation of the pressure roller 121, and presses the pressure roller 121 into contact with the heating roller 110.

The separating roller 122 is made of a metal (such as steel) pipe and has a slip prevention element 200. The diameter of the slip prevention element 200 is approximately the same as that of the separating roller 122.

The separating roller 122 can be formed by a steel pipe. It can also use an elastic layer which is relatively more flexible than the pressure roller 121. A separating roller supporting elastic element 142 may be disposed on both ends of the axis of rotation of the separating roller 122 to press the separating roller 122 into contact with the heating roller 110.

The fusing belt 123 is an endless loop that rotates about an endless track around the pressure roller 121 and the separating roller 122. The fusing belt forms a wide nip with respect to the heating roller 110. The fusing belt 123 may include a base made of a high polymeric material such as polyimide (PI) and polyetheretherketone (PEEK); a layer made of metal such as nickel (Ni) and its alloy or stainless steel, aluminum and its alloy, copper and its alloy; and an elastic layer and a paper release layer additionally formed on the layer.

As will be discussed below, the slip prevention element 200 may have various configurations and may be provided at various locations.

According to a first exemplary embodiment of the present invention illustrated in FIGS. 3 and 4, the slip prevention element 200 is formed by recesses formed on both ends of the separating roller 122, and a friction material 210 filled in the recesses by, for example, coating the recesses with the frictional material. The slip prevention element 200 extends inward approximately 1 to 2 cm from both ends of the separating roller 122, and has about the same diameter as that of the separating roller 122.

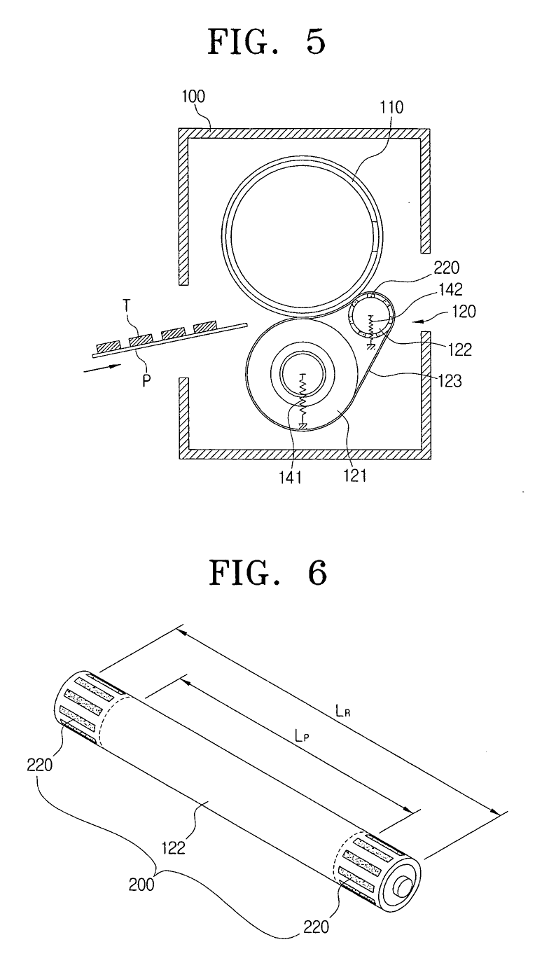

According to a second exemplary embodiment of the present invention illustrated in FIGS. 5 and 6, the slip prevention element 200 includes a plurality of bar shaped slits formed on both ends of the separating roller 122 at intervals. The slits are filled by a friction material 220 by, for example, coating the recesses with the frictional material.

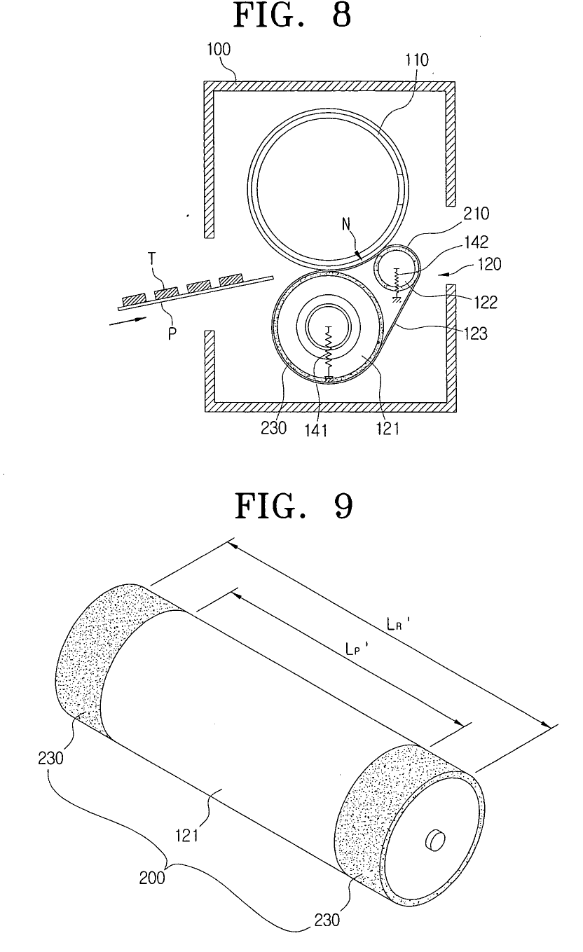

According to a third exemplary embodiment of the present invention illustrated in FIGS. 8 and 9, the slip prevention element 200 formed on both ends of the pressure roller 121, and a friction material 230 filled in the recesses by, for example, coating the recesses with the frictional material. The slip prevention element 200 extends inward approximately 1 to 2 cm from both ends of the pressure roller 121, and has the same diameter as that of the pressure roller 121.

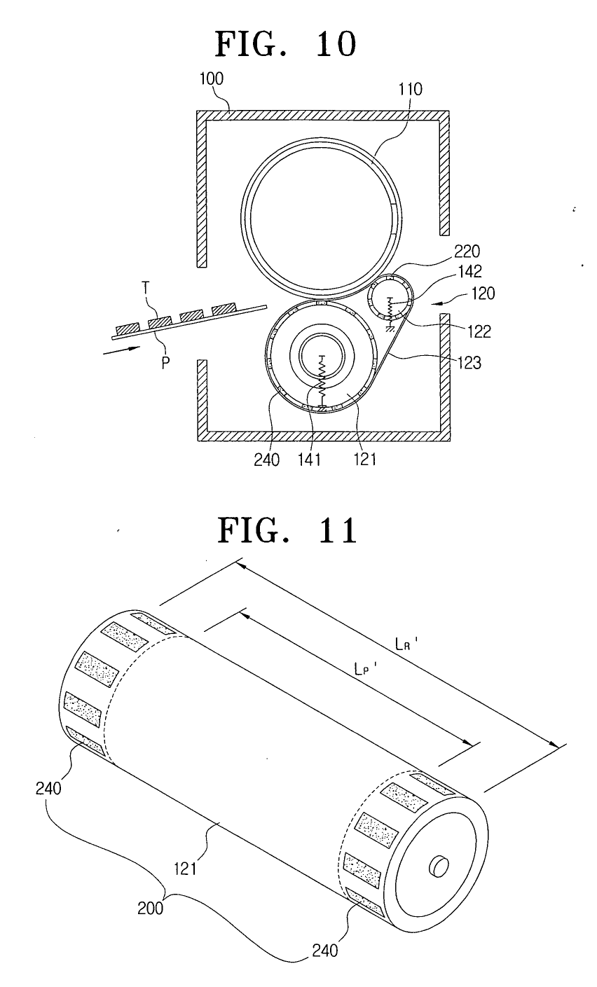

According to a fourth exemplary embodiment of the present invention illustrated in FIGS. 10 and 11, the slip prevention element 200 includes a plurality of bar-shaped slits formed on both ends of the pressure roller 121 at intervals. The slits are filled by a friction material 240 by, for example, coating the recesses with the frictional material.

According to a fifth exemplary embodiment of the present invention illustrated in FIGS. 12, the slip prevention element 200 are formed on an inner surface 123a of the fusing belt 123. The slip prevention element 200 includes recesses formed on both ends of an inner surface 123a of the fusing belt 123, and a friction material 250 filled in the recesses by, for example, coating the recesses with the frictional material. The slip prevention element 200 extends inward approximately 1 to 2 cm from both ends of the fusing belt 123. Additionally, the height of the friction material 250 is such that the slip prevention element 200 is aligned with the outer surface of the fusing belt 123.

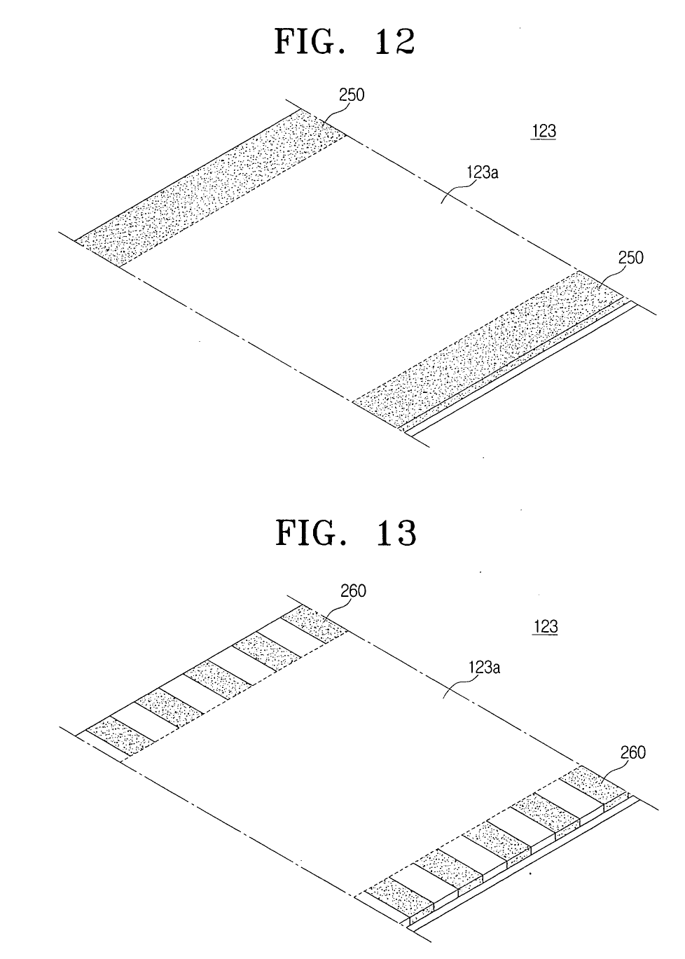

According to a sixth exemplary embodiment of the present invention illustrated in FIG. 13, the slip prevention element 200 includes a plurality of slits formed on both ends of the inner surface 123a of the fusing belt 123 at intervals, and a friction material 260 filled in the slits by, for example, coating the recesses with the frictional material.

The friction materials 210, 220, 230, 240, 250, 260 used in the various exemplary embodiments of the slip prevention element 200 may be one of a silicone rubber, a urethane, or an expandable polystyrene (EPS).

The width (L_{P}′) of the pressure roller 121 or the width (L_{P}) of the separating roller 122, or the width of the fusing belt 123 is preferably greater than that of the paper transferring path to prevent the slip prevention elements from overlapping the paper transferring path (i.e. wider than paper passing through the fusing unit). Alternatively, each of the pressure roller 121, separating roller 122 and the fusing belt 123 may have a wider width (L_{R}′, L_{R}) than that of the paper transferring path.

The elastic layer, such as silicone rubber, may be applied over the entire surface of the separating roller 122, instead of forming the slip prevention elements 200 on both ends of the separating roller 122 as described in the first and the second exemplary embodiments of the present invention. If the elastic layer is formed over the entire separating roller 122, the diameter of the inner part (e.g. the pipe) of the separating roller is smaller. Therefore the separating roller 122 may be bent easily. Accordingly, the separating roller 122 may be easily deformed when the pressure between the separating roller 122 and the heating roller 110 increases, and this may lead to a decrease in fusing efficiency at the center of a paper (P) passing through the fusing unit 100. Moreover, when the driving torque of the passive-driving fusing belt assembly 120 increases, as the fusing belt assembly can be interrupted by an increase in driving torque of the fusing belt assembly 120, which rotates vertically, in the same time, friction between the fusing belt 123 and the separating roller 122 can be excessive, so it can easily be worn away.

In the above described exemplary embodiments of the present invention, the slip prevention element 200 was formed on the pressure roller 121 or the separating roller 122 since these rollers are passively rotated (i.e. they are rotated due to the rotation of the heating roller 110). The slip prevention element 200 may be formed on the heating roller 110, if the fusing belt assembly 120 is actively driven. If the slip prevention element 200 is formed on the heating roller 110, it may also be formed on both sides of the separating roller 122 in the same configuration as in the previous exemplary embodiments.

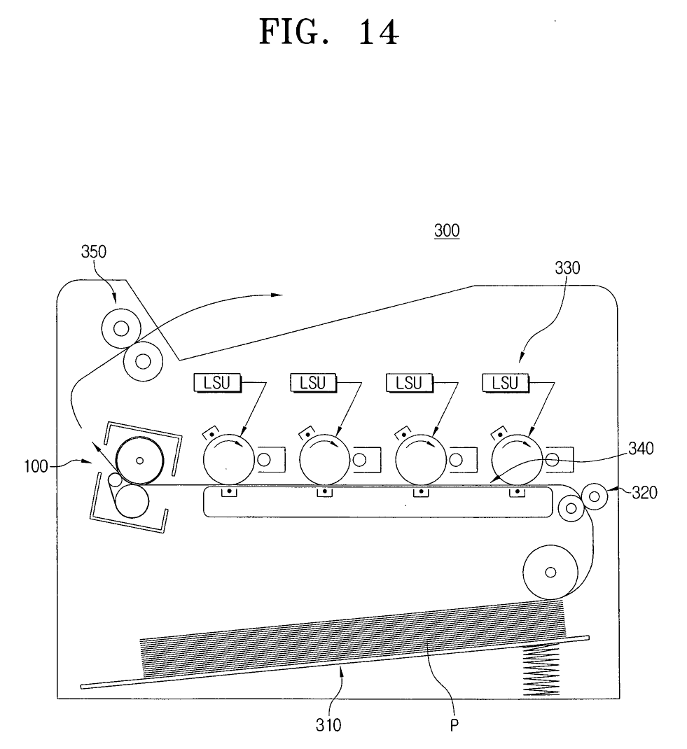

FIG. 14 is a schematic view of an exemplary embodiment of an image forming apparatus having a fusing unit according to an exemplary embodiment of the present invention. The image forming apparatus 300 includes a feeding unit 310, a conveyer 320, a developing unit 330, an image transfer unit 340, a fusing unit 100, and a discharging unit 350.

The feeding unit 310 holds a stack of paper (P). Sheets of paper (P) from the stack of paper (P) are provided to the developing unit 330 and the image transfer unit 340 by the conveyer 320 and receive a toner image. The paper (P) bearing the toner image therein is fused by the heat and pressure from the fusing unit 100, and then discharged outside the image forming apparatus by the discharging unit 350.

As mentioned before, the fusing unit 100 includes the fusing belt assembly 120 including the heating roller 100, the pressure roller 121, the separating roller 122 having the slip prevention element 200, and the fusing belt 123.

The operation of the image forming apparatus according to exemplary embodiments of the present invention will now be described in detail. Since the techniques for forming a toner image are well known to those skilled in the relevant art, a detailed explanation of those operations will be omitted.

As shown in FIGS. 3 and 5, the fusing unit 100 fixes a toner image (T) by applying heat and pressure to the paper (P) bearing a toner image (T).

To fuse the toner image (T), the temperature of the nip (N), that is, the temperature of the contact area between the heating roller 110 and the fusing belt assembly 120 of the fusing unit 100, has to be approximately 180° C. before the fusing process begins. The heating roller 110 rotates to move the paper to a paper distribution tray (not shown), and the fusing belt assembly 120 is passively driven by the rotation of the heating roller 110. To maintain the temperature of the heating roller 110, a sensor may be provided to measure the temperature of the heating roller 110.

Each of the pressure roller 121, separating roller 122, and the fusing belt 123 of the fusing belt assembly 120 is pressed against the heating roller 110, and in this way, a first nip and a second nip are formed between the pressure roller 121 and the heating roller 110, and between the fusing belt 123 and the heating roller 110, respectively.

Therefore, when the paper (P) bearing a toner image (T) is transferred to the fusing unit 100, the heating roller 110 and the fusing assembly 120 move the paper (P), and in this process, the toner image (T) is first fused by pressure between the heating roller 110 and the pressure roller 121 as the paper (P) is passed through the first nip, and completely fused as the paper (P) is passed through the second nip between the heating roller 110 and the fusing roller 123.

Meanwhile, at the connection between the separating roller 122 and the fusing belt 123, slip may occur because the separating roller 122 is made of metal such as a steel pipe. The slip may lead to an irregular rotating speed for the fusing belt 123. If the rotating speed of the fusing belt 123 becomes irregular, the fusing process may be degraded. To prevent this, the slip prevention element 200 is formed at the connection between the separating roller 122 and the fusing belt 123.

It should be noted that the connection between the fusing belt 123 and the slip prevention element 200 may be damaged by friction, and the lifespan of the fusing belt 123 can be shortened if the slip prevention element 200 protrudes from the separating roller 122, as the diameter of the slip prevention element 200 is larger than that of the separating roller 122. Furthermore, the image can be contaminated if the protrusions overlap the path of the paper bearing a toner image (T).

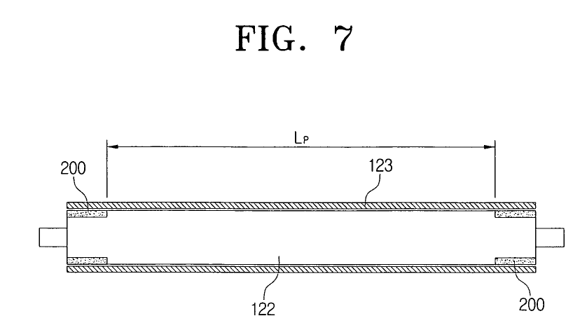

To prevent such image contamination, the slip prevention element 200 according to the exemplary embodiments of the present invention is formed on both sides of the separating roller 122 so as not to overlap the path of the paper bearing a toner image (T), as shown in FIGS. 4, 6 and 7, and prevent the fusing error from occurring by the abrasion of the fusing belt 123 by the contact with the slip prevention element 200. That is, the width (L_{P}) of the roller between the slip prevention elements located on both sides of the roller is wider than the paper passing through the fusing unit (see FIG. 7). In addition, by making the diameter of the slip prevention element 200 as same as that of the separating roller 122, and using a material such as urethane which has a higher coefficient of friction than metal such as steel, error caused by slip between the separating roller 122 and the fusing belt 123 can be prevented.

While the exemplary embodiments of the present invention have been described with respect to a slip prevention element 200 formed on the separating roller 122, the description is also applicable to the other exemplary embodiments. That is, the slip prevention element 200 can be formed at the pressure roller 121, or it can be formed at both the pressure roller 121 and the separating roller 122, or it can be formed on the inner surface 123a of the fusing belt 123.

With the fusing unit 100 as described above in the exemplary embodiments of the present invention, a wider nip (N) is formed than the nip in a conventional 2-roller type fusing unit. Therefore, the quality of printing is improved by the increased size of the nip and the concomitant increase in length of time a paper stays in the nip. Moreover, with an increased nip, the fusing temperature can be kept at a low temperature, thereby reducing the warm-up time.

Since the fusing belt assembly 120 may be passively driven by the movement of the heating roller 110, it does not require an extra driving source. That is, it can be implemented at a relatively low cost and in a simple structure.

According to exemplary embodiments of the present invention, the length of time a paper remains in the nip while passing through the nip is increased, and the temperature of the fusing unit can be decreased, which leads to a decrease in required time for warm-up as well as an improvement in the quality of printing. In addition, the fusing belt is passively driven by the rotation of the heating belt, and it can be implemented at a low cost because it does not need any extra driving force.

Moreover, by using a slip prevention element to prevent slip between the separating roller and the fusing belt, fusing errors caused by slip of the fusing belt is minimized.

Also, since the slip prevention element is disposed at the ends of the separating roller outside of the paper path, image contamination caused by the slip prevention element is minimized.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fusing unit for an image forming apparatus comprising:
a heating roller;
a fusing belt assembly contacting the heating roller, the fusing belt assembly comprising a pressure roller, a separating roller and a fusing belt rotatably supported by the pressure roller and the separating roller; and
a slip prevention element to prevent slip of the fusing belt.

2. A fusing unit for an image forming apparatus according to claim 1, wherein the fusing belt assembly is passively driven by the rotation of the heating roller.

3. A fusing unit for an image forming apparatus according to claim 2, wherein the slip prevention element is disposed at both sides of at least one of the separating roller, the pressure roller and an inner surface of the fusing belt.

4. A fusing unit for an image forming apparatus according to claim 3, wherein the slip prevention element is aligned with the surface of the separating roller, the pressure roller, or the fusing belt having the slip prevention element.

5. A fusing unit for an image forming apparatus according to claim 1, wherein the slip prevention element comprises recesses formed on both sides of the separating roller and a friction material in the recesses.

6. A fusing unit for an image forming apparatus according to claim 5, wherein the slip prevention element is disposed outside a paper transferring path.

7. A fusing unit for an image forming apparatus according to claim 6, wherein the slip prevention element extends approximately 1 to 2 centimeters inward from both edges of the fusing belt.

8. A fusing unit for an image forming apparatus of claim 8, wherein the friction material comprises at least one of a silicon rubber, a urethane or an Expandable Polystyrene (EPS).

9. A fusing unit for an image forming apparatus according to claim 1, the slip prevention element comprises slits formed at intervals on both ends of the pressure roller, and a friction material in the slits.

10. A fusing unit for an image forming apparatus of claim 9, wherein the friction material comprises at least one of a silicon rubber, a urethane or an Expandable Polystyrene (EPS).

11. A fusing unit for an image forming apparatus according to claim 1, wherein in the fusing belt assembly, the pressure roller and the separating roller are elastically pressed against the heating roller to form a nip with the heating roller.

12. A fusing unit for an image forming apparatus according to claim 1, wherein the separating roller and the fusing belt are wider than a paper transferring path so that the slip prevention element does not overlap the paper transferring path.

13. A fusing unit for an image forming apparatus, comprising:
a heating roller;
a fusing belt assembly passively rotated in contact with the heating roller, the fusing belt assembly comprising a pressure roller, a separating roller, and a fusing belt rotatably supported by the pressure roller and the separating roller; and
a slip prevention element to prevent slip between the fusing belt and the separating roller.

14. An image forming apparatus, comprising:
a feeding unit to hold a stack of paper;
a conveyer to convey a sheet of paper from the stack of paper;
a developing unit and an image transfer unit to develop and transfer a toner image onto the sheet of paper conveyed by the conveyor;
a fusing unit to fuse the transferred toner image by applying heat and pressure to the sheet of paper bearing the toner image; and
a discharging unit to discharge the sheet of paper with the fused image,
wherein the fusing unit comprises:
a heating roller;
a fusing belt assembly passively rotated in contact with the heating roller, the fusing belt assembly comprising a pressure roller, a separating roller, and a fusing belt rotatably supported by the pressure roller and the separating roller; and
a slip prevention element to prevent slip between the fusing belt and the separating roller.

15. An image forming apparatus according to claim 14, wherein the slip prevention element is disposed at both sides of at least one of the separating roller, the pressure roller and an inner surface of the fusing belt.

16. An image forming apparatus according to claim 15, wherein the slip prevention element is aligned with the surface of the separating roller, the pressure roller, or the fusing belt having the slip prevention element.

17. An image forming apparatus according to claim 16, wherein the friction material comprises at least one of a silicon rubber, a urethane or an Expandable Polystyrene (EPS).

18. An image forming apparatus according to claim 14, wherein the slip prevention element comprises recesses extending inward from both ends of the separating roller by approximately 1 or 2 centimeters, and a friction material in the recesses.

19. An image forming apparatus according to claim 18, wherein the friction material comprises at least one of a silicon rubber, a urethane or an Expandable Polystyrene (EPS).

20. An image forming apparatus according to claim 14, wherein the slip prevention element comprises slits formed at intervals on both ends of the pressure roller, and a friction material in the slits.

21. An image forming apparatus according to claim 20, wherein the friction material comprises at least one of a silicon rubber, a urethane or an Expandable Polystyrene (EPS).

22. An image forming apparatus according to claim 14, wherein in the fusing belt assembly, the pressure roller and the separating roller are pressed against the heating roller by an elastic member so as to form a nip with the heating roller.

23. A fusing belt for a fusing unit for an image forming apparatus comprising:
an endless belt having an inner surface; and
a slip prevention element disposed on an inner surface of the fusing belt.

24. A fusing belt according to claim 23, wherein the slip prevention element comprises frictional material disposed at both edges of the inner surface of the belt.

25. A fusing belt according to claim 24, wherein the slip prevention elements extend inwardly for approximately 1 to 2 cm from the edges of the belt.

26. A fusing belt according to claim 24, wherein the frictional material is disposed in recesses formed along the edges of the belt.

27. A fusing belt according to claim 26, wherein the recesses are continuous along the edges of the belt.

28. A fusing belt according to claim 26, wherein the recesses are formed at intervals along the edges of the belt.

29. A fusing belt according to claim 23, wherein the friction material comprises at least one of a silicon rubber, a urethane or an Expandable Polystyrene (EPS).
